(19) United States
(12) Patent Application Publication
(10) Pub. No.: US 2005/0135809 A1
(43) Pub. Date: Jun. 23, 2005

(54) Service and resource management framework for optical networks

(76) Inventors: Paddy Vishnubhatt, Los Alto, CA (US); Saravanan R. Coimbatore, Sunnyvale, CA (US); Rakesh Rao, Mountain View, CA (US); Hasnain Rashid, Menlo Park, CA (US); Sarwat Aleemjee, San Jose, CA (US)

Correspondence Address: SAWYER LAW GROUP LLP, P O BOX 51418, PALO ALTO, CA, 94303, US

(21) Appl. No.: 10/745,888

(22) Filed: Dec. 23, 2003

(51) Int. Cl. H04J 14/00

(52) U.S. Cl. 398/66

(57) ABSTRACT

A method and system for interfacing a client and a network management server for provisioning services on an optical network, includes: providing a user interface at the client for provisioning a service in the optical network utilizing non-service specific presentation code and a data file at the client, where the data file includes parameters specific to the service; receiving data for the parameters from the client by a network management server; mapping the data for the parameters from the client to a network management server representation of the parameters; and mapping the network management server representation of the parameters to a network element specific format. When a new type of service is to be provisioned, the data files can be modified without needing to modify the presentation code.

### FIELD OF THE INVENTION

The present invention relates to optical networks, and more particularly to the client/server interface for provisioning services on optical networks.

### BACKGROUND OF THE INVENTION

FIG. 1 illustrates a conventional optical network. The network comprises a plurality of rings 104 managed by a network management server 103. Each ring has a plurality of network elements 105. The network elements 105 could be any entity which places traffic on or takes traffic off a ring. Typically, when a new service is to be provisioned, a user at a client 101 provides the parameters for the new service via a service specific user interface (UI) 102. The service specific UI 102 has knowledge of the data format required for the network elements 105 and of the particular parameters required for a particular service. Thus, the UI 102 requests the appropriate parameters for a particular type of service to be provisioned. However, with the conventional UI 102, whenever a new type of service requiring a different set of parameters is to be provisioned, the presentation code for the UI 102 must be changed. Otherwise, the UI 102 would not request the appropriate parameters for the new service. The conventional system is thus inflexible.

Accordingly, there exists a need for an improved method and system for interfacing a client and a network management server for provisioning services on an optical network. The present invention addresses such a need.

### SUMMARY OF THE INVENTION

A method and system for interfacing a client and a network management server for provisioning services on an optical network, includes: providing a user interface at the client for provisioning a service in the optical network utilizing non-service specific presentation code and a data file at the client, where the data file includes parameters specific to the service; receiving data for the parameters from the client by a network management server; mapping the data for the parameters from the client to a network management server representation of the parameters; and mapping the network management server representation of the parameters to a network element specific format. When a new type of service is to be provisioned, the data files can be modified without needing to modify the presentation code.

### BRIEF DESCRIPTION OF THE FIGURES

FIG. 1 illustrates a conventional optical network.

FIG. 2 illustrates a preferred embodiment of a system for interfacing a client and a network management server for provisioning services on an optical network in accordance with the present invention.

FIG. 3 is a flowchart illustrating a preferred embodiment of a method for interfacing a client and a network management server for provisioning services on an optical network in accordance with the present invention.

FIGS. 4A through 4D illustrate an example of the user interface provided for provisioning a point to point service in accordance with the present invention.

FIGS. 5A through 5D illustrate an example of the user interface provided for provisioning a point to multipoint service in accordance with the present invention.

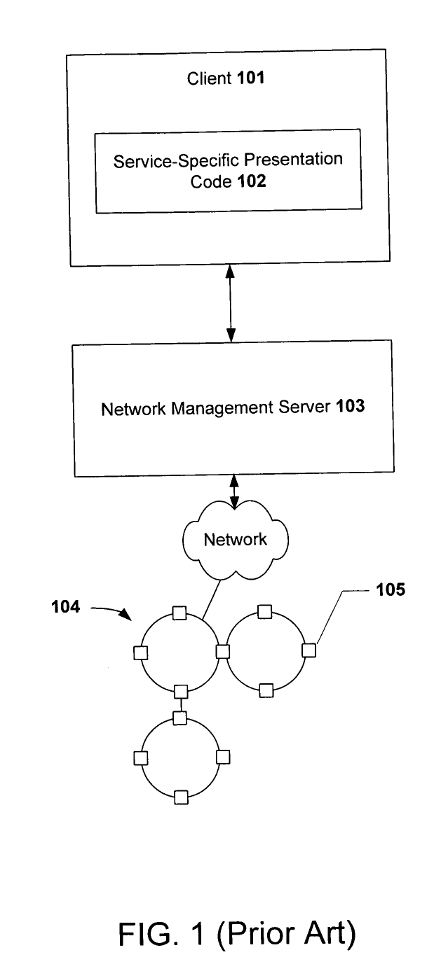

### DETAILED DESCRIPTION

The present invention provides an improved method and system for interfacing a client and a network management server for provisioning services on an optical network. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

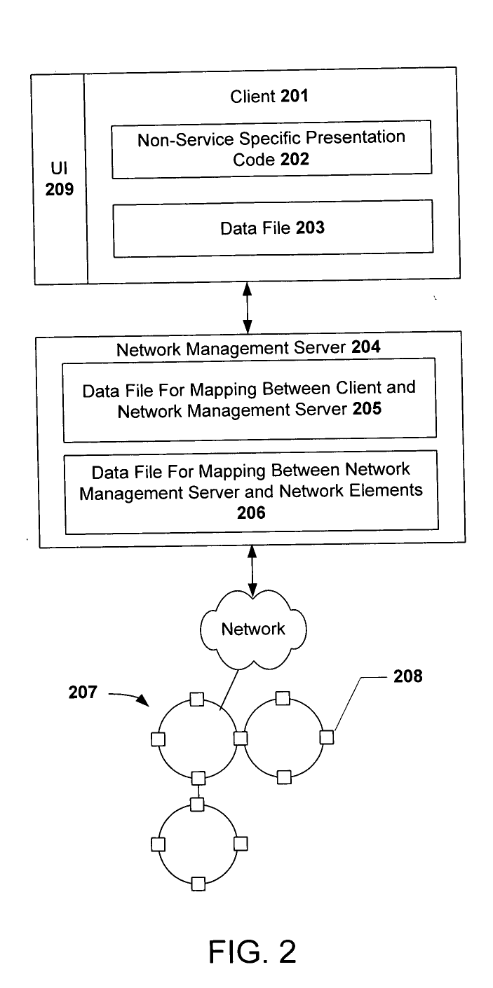

To more particularly describe the features of the present invention, please refer to FIGS. 2 through 5D in conjunction with the discussion below.

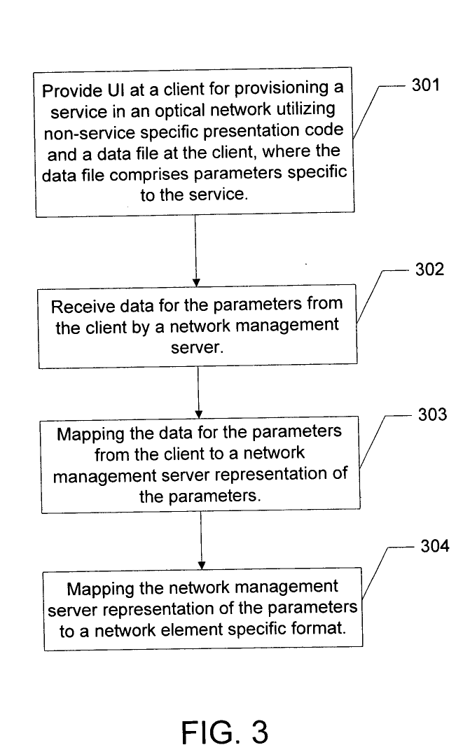

FIG. 2 illustrates a preferred embodiment of a system and FIG. 3 is a flowchart illustrating a preferred embodiment of a method for interfacing a client and a network management server for provisioning services on an optical network in accordance with the present invention. Referring to both FIGS. 2 and 3, the system comprises an optical network comprising a plurality of rings 207. Each ring comprises a plurality of network elements 208. A network management server (NMS) 204 manages the configuration of the optical network. A user, through the client 201 can interact with a user interface (UI) 209 to provision a service on the network. In the preferred embodiment, the UI 209 is provided using a non-service specific presentation code 202 and a data file 203. Each service is represented by a hierarchy of parameters at the port level, shelf level, ring level, and network level. The exact parameters at each level are specific to the service. These exact parameters are specified in the data file 203. The UI 209 is then provided at the client 201 for provisioning the service utilizing the non-specific presentation code 202 and the data file 203, via step 301. The presentation code 202 reads the data file 203 and modifies the UI 209 so that it presents the exact parameters at each level for the service to provisioned. The user then enters the data for these parameters through the UI 209. The data for the service is then bundled and sent to the NMS 204. Once the data for the parameters is received by the NMS 204, via step 302, the NMS 204 maps the data for the service received from the client 201 to a NMS representation of the parameters, using the data file 205, via step 303. Then, the NMS representation of the parameters is mapped to a network element specific format, using the data file 206, via step 304.

Because of the mapping performed in step 303, the presentation of the service at the client 201 is decoupled from the representation of the service in the network elements 208. This allows the presentation code 201 to be non-service specific. Thus, when a new type of service is to be provisioned, the exact parameters for the service can be provided in the data file 203 at the client and the data file 205 at the NMS 204. The UI 209 can then be modified to present these parameters without the need to change the presentation code 202. Also, the user need not have knowledge of the network element specific format for the service's data.

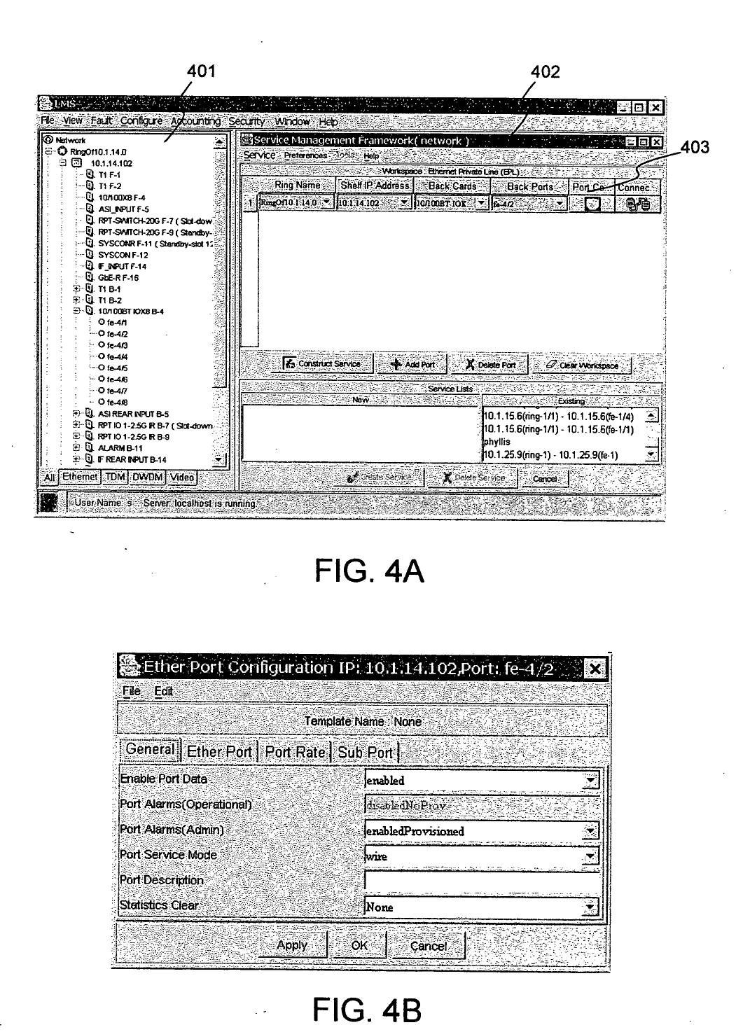

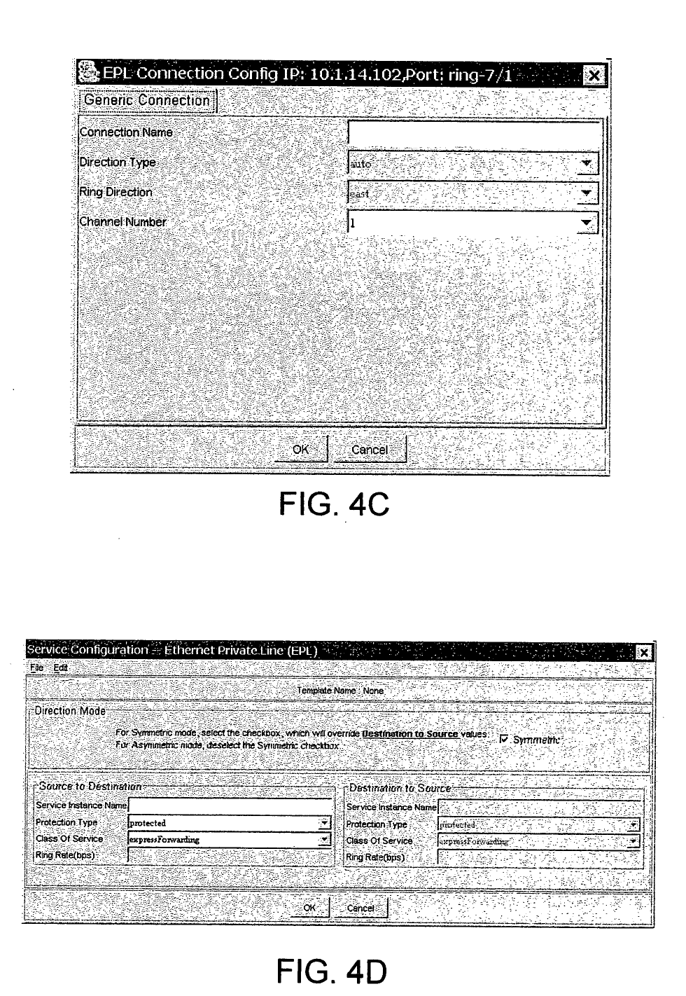

FIGS. 4A through 4D illustrate an example of the UI 209 provided for provisioning a point to point service in accordance with the present invention. This example pertains to the provisioning of an Ethernet Private Line (EPL) service. FIG. 4A illustrates the UI 209 with a tree view 401 of possible services and ports, and a service management framework (SMF) window 402. In this example, one endpoint of the service, port fe-4/2 on shelf 10.1.14.102, to be provisioned is dragged in from tree view 401 to the SMF window 402. FIG. 4B illustrates the UI 209 for specifying the port level parameters. This includes items such as service mode, alarms enable and bandwidth. The user can reach this screen by clicking on the Port Connection button 403 in the SMF window 402. Optionally, parameters that vary on a ring by ring basis only needs to be specified only if the user is manually provisioning the service without the help of a Path Engine on the NMS 204. The Path Engine (not shown) has the capability to discover the optimal route between the given endpoints and choose the ring level parameters accordingly. FIG. 4C illustrates the UI 209 for specifying the ring level parameters. The ring level parameters include the traffic direction and channel chosen on each ring. FIG. 4D illustrates the UI 209 for specifying the network level parameters, such as the service ID, class of service and protection type. The UI 209 for the EPL service is provided using the non-service specific presentation code 202 and the EPL parameters in the data file 203. However, this is transparent to the user.

For a multi-ring service, the path between the given endpoints includes not only the endpoint ports but also the ports at the two ends of each intervening ring. The port level objects representing these ports are the ones that are provisioned or transmitted to the network elements. Hence the network level and ring level parameters are percolated down to the port level objects before provisioning can occur. Some of the salient variables at the port, ring and network level are listed below.

Variables in server side port level object:
Interface index of port.
Interface index to send data to.
Label to look for on received packets.
Next hop IP address to transmit data to.
Label to prepend on transmitted packets.
Class of service.
Protection type.
Requested ring direction to transmit to.
Requested ring direction to receive from.
Requested channel number.
Service ID.
Service type.
Connection name.
Transmit bandwidth.
Receive bandwidth.

Variables in server side ring level object:
Service ID.
Shelf at one end of the ring.
Slot of one end.
Port number of one end.
Shelf at other end of the ring.
Slot of other end.
Port of other end.
Service type.

Variables in server side network level object:
Service ID.
Shelf at one end of the network.
Slot of one end.
Port number of one end.
Shelf at other end of the network.
Slot of other end.
Port of other end.
Service type.
Protection type.
Class of service.

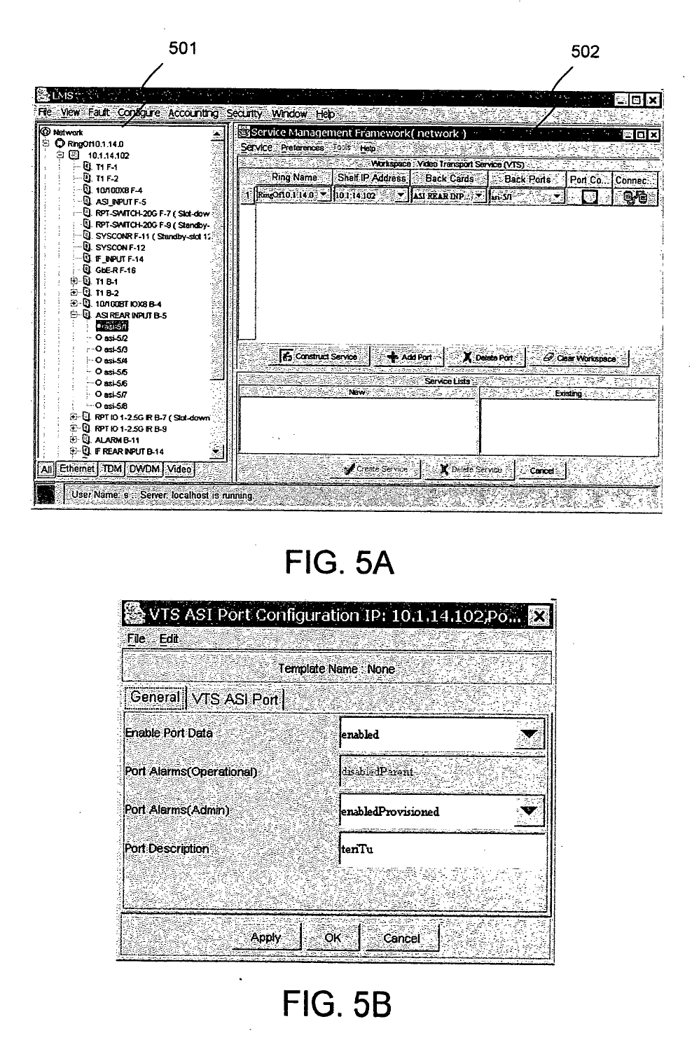

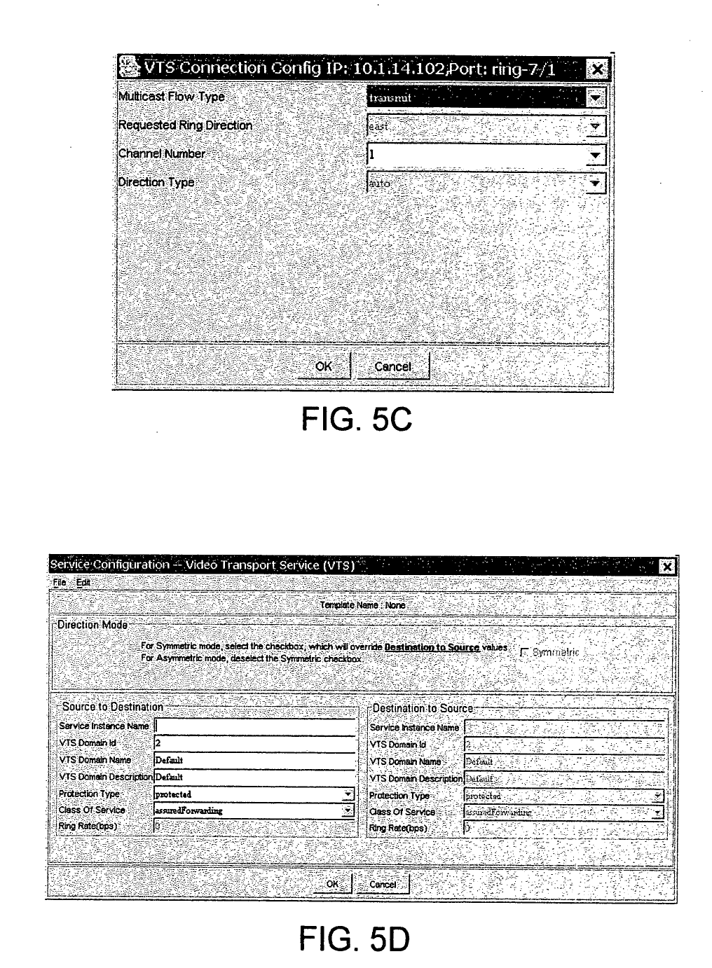

FIGS. 5A through 5D illustrate an example of the UI 209 provided for provisioning a point to multipoint service in accordance with the present invention. This example pertains to the provisioning of a video Transport Services (VTS). FIG. 5A illustrates the UI 209 with a tree view 501 of possible services and ports, and a SMF window 502. In this example, the input endpoint of the service, port asi-5/1 on shelf 10.1.14.102, to be provisioned is dragged in from tree view 501 to the SMF window 502. FIG. 5B illustrates the UI 209 for specifying the port level parameters. FIG. 5C illustrates the UI 209 for specifying the ring level parameters, which includes the multicast flow type. FIG. 5D illustrates the UI 209 for specifying the network level parameters. The UI 209 for the VTS is provided using the non-service specific presentation code 202 and the VTS parameters in the data file 203. However, this is transparent to the user.

When the data is received by the NMS 204, via step 302, the parameters at the port, ring, and network levels are mapped to the NMS representation of these parameters, via step 303, utilizing the data file 205. Next, the NMS representation of the service is mapped to the network element specific format, via step 304, utilizing the data file 206. In this manner, non-service specific code can be used to provide the UI 209. Thus, new code is not required when a new type of service is to be provisioned.

A method and system for interfacing a client and a network management server for provisioning services on an optical network has been disclosed. Non-service specific presentation code and a data file with parameters for services. At a network management server resides a data file for mapping between the client and the network management server and a data file for mapping between the network management server and network elements.

The non-service presentation specific code reads the data file and modifies the UI so that it presents the exact parameters at each level for the service to be provisioned. The user may enter the data for these parameters through the UI. This data is then sent to the network management server, where the parameters are mapped first to a network management server representation, and then to the network element format, using the data files at the network management server. In this manner, the presentation of the service at the client is decoupled form the representation of the service in the network elements. Thus, when a new type of service is to be provisioned, the data files can be modified without needing to modify the presentation code.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for interfacing a client and a network management server for provisioning services on an optical network, comprising:
(a) providing a user interface at the client for provisioning a service in the optical network utilizing non-service specific presentation code and a data file at the client, wherein the data file comprises parameters specific to the service;
(b) receiving data for the parameters from the client by a network management server;
(c) mapping the data for the parameters from the client to a network management server representation of the parameters; and
(d) mapping the network management server representation of the parameters to a network element specific format.

2. The method of claim 1, wherein the providing (a) comprises:
(a1) reading the data file at the client by the non-service specific presentation code;
(a2) modifying the user interface to present the parameters in the data file; and
(a3) providing the modified user interface at the client.

3. The method of claim 2, further comprising:
(a4) receiving the data for the parameters;
(a5) bundling the data for the parameters; and
(a6) sending the bundled data to the network management server.

4. The method of claim 1, wherein the mapping (c) comprises:
(c1) mapping the data for the parameters from the client to the network management server representation of the parameters utilizing a first data file at the network management server.

5. The method of claim 1, wherein the mapping (d) comprises:
(d1) mapping the network management server representation of the parameters to the network element specific format utilizing a second data file at the network management server.

6. The method of claim 1, further comprising:
(e) modifying the data file at the client with parameters for a new service to be provisioned; and
(f) providing the user interface at the client for provisioning the new service in the optical network utilizing the non-service specific presentation code and the modified data file at the client, wherein the non-service specific presentation code is not modified.

7. A computer readable medium with program instructions for interfacing a client and a network management server for provisioning services on an optical network, comprising the instructions for:
(a) providing a user interface at the client for provisioning a service in the optical network utilizing non-service specific presentation code and a data file at the client, wherein the data file comprises parameters specific to the service;
(b) receiving data for the parameters from the client by a network management server;
(c) mapping the data for the parameters from the client to a network management server representation of the parameters; and
(d) mapping the network management server representation of the parameters to a network element specific format.

8. The medium of claim 7, wherein the providing instruction (a) comprises instructions for:
(a1) reading the data file at the client by the non-service specific presentation code;
(a2) modifying the user interface to present the parameters in the data file at the client; and
(a3) providing the modified user interface at the client.

9. The medium of claim 8, further comprising instructions for:
(a4) receiving the data for the parameters;
(a5) bundling the data for the parameters; and
(a6) sending the bundled data to the network management server.

10. The medium of claim 7, wherein the mapping instruction (c) comprises instructions for:
(c1) mapping the data for the parameters from the client to the network management server representation of the service utilizing a first data file at the network management server.

11. The medium of claim 7, wherein the mapping instruction (d) comprises instructions for:
(d1) mapping the network management server representation of the service to the network element specific format utilizing a second data file at the network management server.

12. The medium of claim 7, further comprising instructions for:
(e) modifying the data file at the client with parameters for a new service to be provisioned; and
(f) providing the user interface at the client for provisioning the new service in the optical network utilizing the non-service specific presentation code and the modified data file at the client, wherein the non-service specific presentation code is not modified.

13. A system, comprising:
a client, comprising:
non-service specific presentation code, and
a first data file comprising parameters for services that can be provisioned on an optical network; and
a network management server, comprising:
a second data file for mapping the parameters in the first data file to a network management server representation of the parameters, and
a third data file for mapping the network management server representation of the parameters to a network element format.
